(19) United States
(12) Patent Application Publication
(10) Pub. No.: US 2025/0173969 A1
(43) Pub. Date: May 29, 2025

(54) THREE-DIMENSIONAL MAPPING USING DISPARATE VISUAL DATASETS

(71) Applicant: Snap Inc., Santa Monica, CA (US)

(72) Inventors: Sean Gorman, Louisville, CO (US); Christopher Helm, Salida, CO (US); Pramukta Kumar, Austin, TX (US)

(21) Appl. No.: 19/039,292

(22) Filed: Jan. 28, 2025

Related U.S. Application Data
(63) Continuation of application No. 17/970,810, filed on Oct. 21, 2022, now Pat. No. 12,243,167.
(60) Provisional application No. 63/335,552, filed on Apr. 27, 2022.

(51) Int. Cl. G06T 17/20; G06T 3/4007; G06T 3/4038

(52) U.S. Cl. CPC G06T 17/20; G06T 3/4007; G06T 3/4038

(57) ABSTRACT

A three-dimensional (3D) mapping system can be configured to generate a 3D map of a real-world environment using annotation of large image data sets, in which terrestrial imagery can be programmatically labeled with accurate labels using remotely sensed overhead image data. The 3D mapping system can implement photogrammetry to create a point cloud. Each pixel in the point cloud can be classified based on a consensus of each frame. The point cloud can be co-registered to a remotely sensed reference dataset to provide precise spatial coordinates for each pixel. Different patches of point clouds can be stitched together to provide a complete 3D map for a given area, such as a downtown area of a city.

### CROSS REFERENCE TO RELATED APPLICATIONS

This application is a continuation of U.S. patent application Ser. No. 17/970,810, filed Oct. 21, 2022, which application claims the benefit of priority to U.S. Provisional Application No. 63/335,552, filed on Apr. 27, 2022, each of which are incorporated herein by reference in their entireties.

### TECHNICAL FIELD

The present disclosure generally relates to special-purpose machines that manage data processing and improvements to such variants, and to the technologies by which such special-purpose machines become improved compared to other special-purpose machines for image processing using disparate vision datasets.

### BACKGROUND

It is computationally difficult to generate three-dimensional (3D) maps of real-world environments. Implementing robotic and computer vision systems to map real-world environments involves significant expenditures in computer vision and robotic equipment and computationally intensive processing to generate accurate results.

### BRIEF DESCRIPTION OF THE DRAWINGS

To easily identify the discussion of any particular element or act, the most significant digit or digits in a reference number refer to the figure (“FIG.”) number in which that element or act is first introduced.

FIG. 1 is a block diagram showing an example messaging system for exchanging data (e.g., messages and associated content) over a network, according to example embodiments.

FIG. 2 is a block diagram illustrating further details regarding the messaging system of FIG. 1, according to example embodiments.

FIG. 3 is a schematic diagram illustrating data which may be stored in a database of a messaging server system, according to certain example embodiments.

FIG. 4 is a schematic diagram illustrating a structure of a message, according to some embodiments, generated by a messaging client application for communication.

FIG. 5 is a schematic diagram illustrating an example access-limiting process, in terms of which access to content (e.g., an ephemeral message, and associated multimedia payload of data) or a content collection (e.g., an ephemeral message story) may be time-limited (e.g., made ephemeral), according to some example embodiments.

FIG. 6 shows an example flow diagram for generating a map from disparate image sources, according to some example embodiments.

FIG. 7 shows devices generating disparate sets of image data from orthogonal perspectives, according to some example embodiments.

FIG. 8 shows a 3D map generated from disparate data, according to some example embodiments.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

One challenge in computer vision is generating adequate amounts of training data for the massive growth in a variety of use cases. Well labeled terrestrial training data generally requires significant expenditures in devices to capture the data (e.g., cars with LIDAR (light detection and ranging) and imaging systems driving around city to collect data on the city). Further, these approaches require significant computing resources to generate accurate results (e.g., generate accurate point clouds or 3D maps of the city from the large amounts of LIDAR and image data). It is further difficult to generate 3D maps using remotely sensed data. Examples of remotely sensed data include drone generated image or video data and remotely sensed data purchased from companies that own aerial systems (e.g., planes, satellites, in accordance with some example embodiments). To address the foregoing issues, a 3D mapping system can be configured to generate a 3D map of a real-world environment using annotation of large image data sets (e.g., end-user provided video provided by one or more end-users of a network site). The image data sets comprise terrestrial imagery that can be programmatically labeled (e.g., neural network image segmentation) with accurate labels, where the label accuracy is improved and augmented with the remotely sensed overhead image data (e.g., aerial LIDAR) and also location data (e.g., GPS data). In some example embodiments, the 3D mapping system implements photogrammetry (e.g., Alice Vision, COLMAP) to create a point cloud from images (e.g., video clips of a city). Each pixel in the point cloud can be classified based on a consensus of each frame of a given video. The point cloud can be co-registered to a remotely sensed reference dataset (e.g., aerial device provided data) to provide precise spatial coordinates for each pixel. Different patches of the point cloud can be stitched together to provide a complete 3D map for a given area, such as a downtown area of a city.

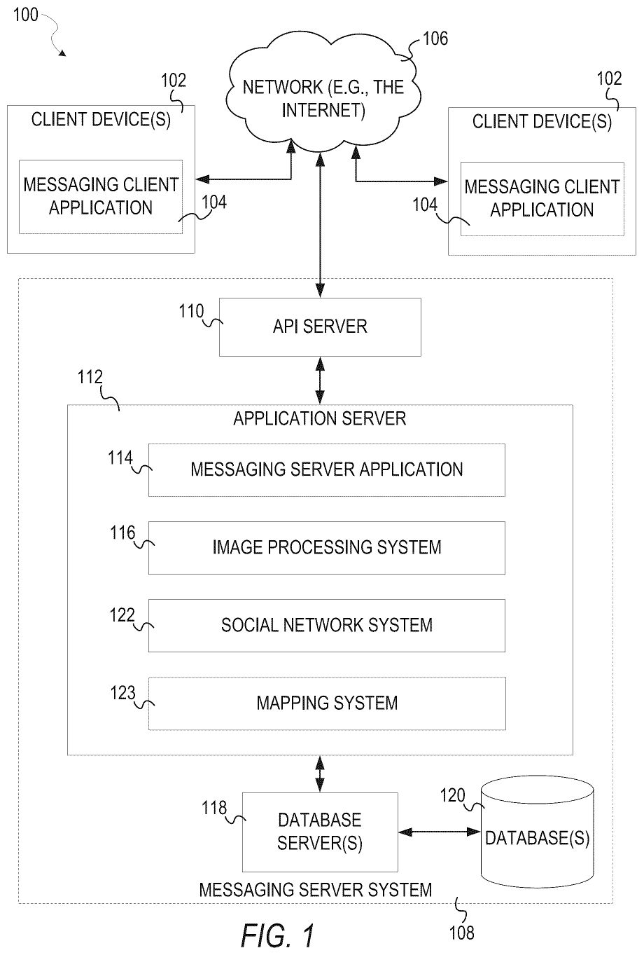

FIG. 1 shows a block diagram of an example messaging system 100 for exchanging data (e.g., messages and associated content) over a network 106. The messaging system 100 includes multiple client devices 102, each of which hosts a number of applications including a messaging client application 104. Each messaging client application 104 is communicatively coupled to other instances of the messaging client application 104 and a messaging server system 108 via the network 106 (e.g., the Internet).

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video, or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality within either the messaging client application 104 or the messaging server system 108 is a design choice. For example, it may be technically preferable to initially deploy certain technology and functionality within the messaging server system 108, and to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. This data may include message content, client device information, geolocation information, media annotation and overlays, message content persistence conditions, social network information, and live event information, as examples. Data exchanges within the messaging system 100 are invoked and controlled through functions available via user interfaces of the messaging client application 104.

Turning now specifically to the messaging server system 108, an application programming interface (API) server 110 is coupled to, and provides a programmatic interface to, an application server 112. The application server 112 is communicatively coupled to a database server 118, which facilitates access to a database 120 in which is stored data associated with messages processed by the application server 112.

The API server 110 receives and transmits message data (e.g., commands and message payloads) between the client devices 102 and the application server 112. Specifically, the API server 110 provides a set of interfaces (e.g., routines and protocols) that can be called or queried by the messaging client application 104 in order to invoke functionality of the application server 112. The API server 110 exposes various functions supported by the application server 112, including account registration; login functionality; the sending of messages, via the application server 112, from a particular messaging client application 104 to another messaging client application 104; the sending of media files (e.g., images or video) from a messaging client application 104 to a messaging server application 114 for possible access by another messaging client application 104; the setting of a collection of media data (e.g., a story); the retrieval of such collections; the retrieval of a list of friends of a user of a client device 102; the retrieval of messages and content; the adding and deletion of friends to and from a social graph; the location of friends within the social graph; and opening application events (e.g., relating to the messaging client application 104).

The application server 112 hosts a number of applications and subsystems, including the messaging server application 114, an image processing system 116, a social network system 122, and mapping system 123. The messaging server application 114 implements a number of message-processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor- and memory-intensive processing of data may also be performed server-side by the messaging server application 114, in view of the hardware requirements for such processing.

The application server 112 also includes the image processing system 116, which is dedicated to performing various image processing operations, typically with respect to images or video received within the payload of a message at the messaging server application 114.

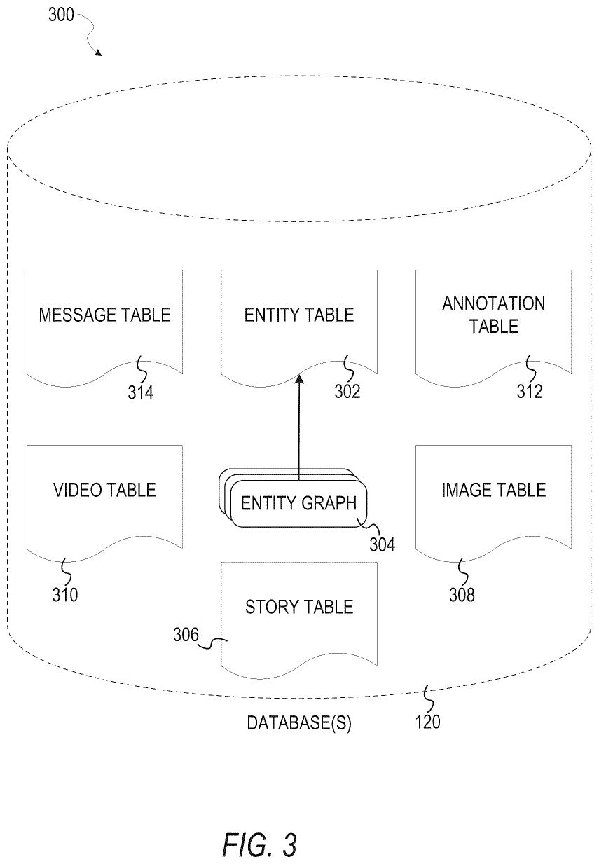

The social network system 122 supports various social networking functions and services and makes these functions and services available to the messaging server application 114. To this end, the social network system 122 maintains and accesses an entity graph (e.g., entity graph 304 in FIG. 3) within the database 120. Examples of functions and services supported by the social network system 122 include the identification of other users of the messaging system 100 with whom a particular user has relationships or whom the particular user is “following,” and also the identification of other entities and interests of a particular user. The application server 112 is communicatively coupled to a database server 118, which facilitates access to a database 120 in which is stored data associated with messages processed by the messaging server application 114. The mapping system 123 is configured to generate 3D maps from disparate image sources, as discussed in further detail below.

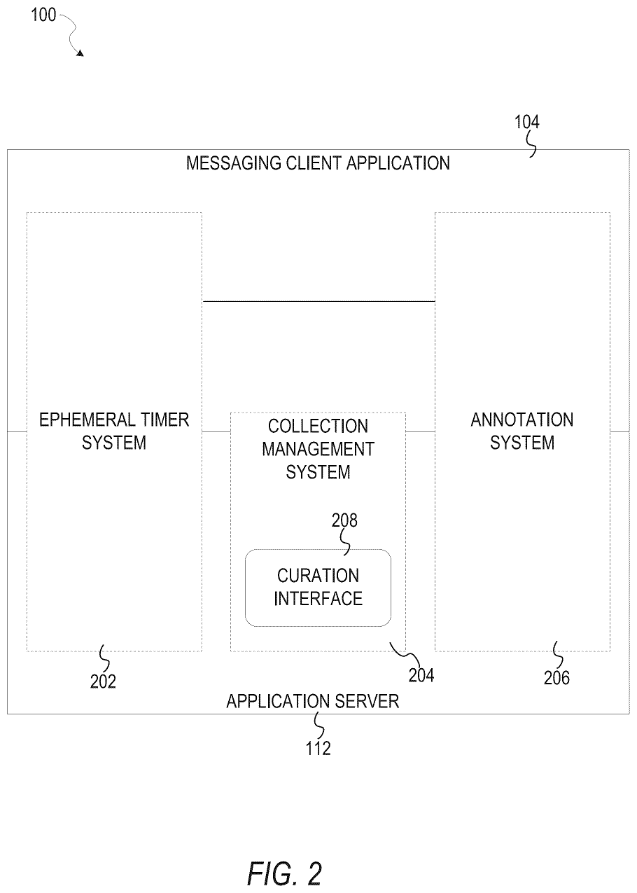

FIG. 2 is a block diagram illustrating further details regarding the messaging system 100, according to example embodiments. Specifically, the messaging system 100 is shown to comprise the messaging client application 104 and the application server 112, which in turn embody a number of subsystems, namely an ephemeral timer system 202, a collection management system 204, and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message or collection of messages (e.g., a story), selectively display and enable access to messages and associated content via the messaging client application 104. Further details regarding the operation of the ephemeral timer system 202 are provided below.

The collection management system 204 is responsible for managing collections of media (e.g., collections of text, image, video, and audio data). In some examples, a collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user-generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of media overlays for messages processed by the messaging system 100. The annotation system 206 operatively supplies a media overlay (e.g., a geofilter or filter) to the messaging client application 104 based on a geolocation of the client device 102. In another example, the annotation system 206 operatively supplies a media overlay to the messaging client application 104 based on other information, such as social network information of the user of the client device 102. A media overlay may include audio and visual content and visual effects. Examples of audio and visual content include pictures, text, logos, animations, and sound effects. An example of a visual effect includes color overlaying. The audio and visual content or the visual effects can be applied to a media content item (e.g., a photo) at the client device 102. For example, the media overlay includes text that can be overlaid on top of a photograph generated by the client device 102. In another example, the media overlay includes an identification of a location (e.g., Venice Beach), a name of a live event, or a name of a merchant (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map and upload content associated with the selected geolocation. The user may also specify circumstances under which particular content should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest-bidding merchant with a corresponding geolocation for a predefined amount of time.

FIG. 3 is a schematic diagram illustrating data 300 which may be stored in the database 120 of the messaging server system 108, according to certain example embodiments. While the content of the database 120 is shown to comprise a number of tables, it will be appreciated that the data 300 could be stored in other types of data structures (e.g., as an object-oriented database). The database 120 includes message data stored within a message table 314. An entity table 302 stores entity data, including an entity graph 304. Entities for which records are maintained within the entity table 302 may include individuals, corporate entities, organizations, objects, places, events, and so forth. Regardless of type, any entity regarding which the messaging server system 108 stores data may be a recognized entity. Each entity is provided with a unique identifier, as well as an entity type identifier (not shown).

The entity graph 304 furthermore stores information regarding relationships and associations between or among entities. Such relationships may be social, professional (e.g., work at a common corporation or organization), interest-based, or activity-based, for example.

The database 120 also stores annotation data, in the example form of filters, in an annotation table 312. Filters for which data is stored within the annotation table 312 are associated with and applied to videos (for which data is stored in a video table 310) and/or images (for which data is stored in an image table 308). Filters, in one example, are overlays that are displayed as overlaid on an image or video during presentation to a recipient user. Filters may be of various types, including user-selected filters from a gallery of filters presented to a sending user by the messaging client application 104 when the sending user is composing a message. Other types of filters include geolocation filters (also known as geo-filters), which may be presented to a sending user based on geographic location. For example, geolocation filters specific to a neighborhood or special location may be presented within a user interface by the messaging client application 104, based on geolocation information determined by a Global Positioning System (GPS) unit of the client device 102. Another type of filter is a data filter, which may be selectively presented to a sending user by the messaging client application 104, based on other inputs or information gathered by the client device 102 during the message creation process. Examples of data filters include a current temperature at a specific location, a current speed at which a sending user is traveling, a battery life for a client device 102, or the current time.

Other annotation data that may be stored within the image table 308 is so-called “lens” data. A “lens” may be a real-time special effect and sound that may be added to an image or a video.

As mentioned above, the video table 310 stores video data which, in one embodiment, is associated with messages for which records are maintained within the message table 314. Similarly, the image table 308 stores image data associated with messages for which message data is stored in the message table 314. The entity table 302 may associate various annotations from the annotation table 312 with various images and videos stored in the image table 308 and the video table 310.

A story table 306 stores data regarding collections of messages and associated image, video, or audio data, which are compiled into a collection (e.g., a story or a gallery). The creation of a particular collection may be initiated by a particular user (e.g., each user for whom a record is maintained in the entity table 302). A user may create a “personal story” in the form of a collection of content that has been created and sent/broadcast by that user. To this end, the user interface of the messaging client application 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices 102 have location services enabled and are at a common location or event at a particular time may, for example, be presented with an option, via a user interface of the messaging client application 104, to contribute content to a particular live story. The live story may be identified to the user by the messaging client application 104 based on his or her location. The end result is a “live story” told from a community perspective.

A further type of content collection is known as a “location story,” which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus).

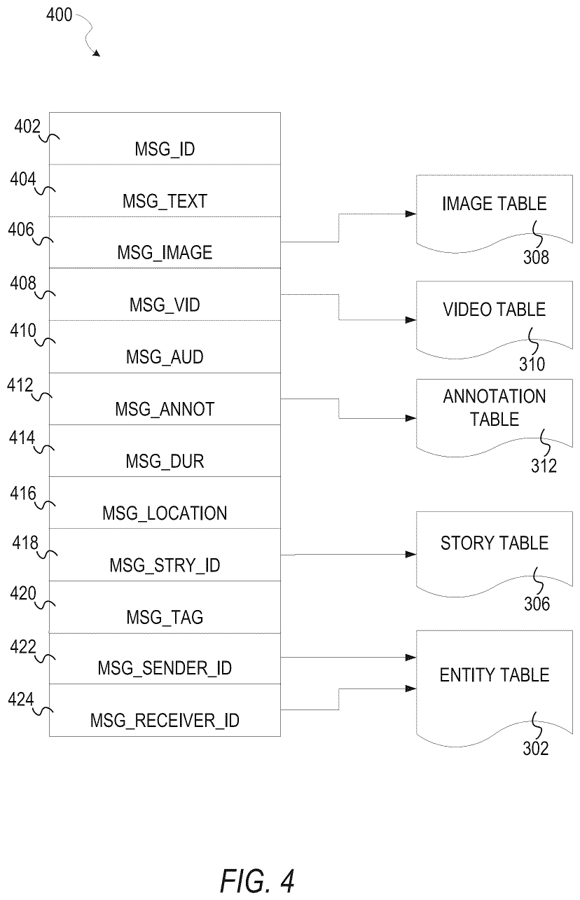

FIG. 4 is a schematic diagram illustrating a structure of a message 400, according to some embodiments, generated by a messaging client application 104 for communication to a further messaging client application 104 or the messaging server application 114. The content of a particular message 400 is used to populate the message table 314 stored within the database 120, accessible by the messaging server application 114. Similarly, the content of a message 400 is stored in memory as “in-transit” or “in-flight” data of the client device 102 or the application server 112. The message 400 is shown to include the following components:
A message identifier 402: a unique identifier that identifies the message 400.
A message text payload 404: text, to be generated by a user via a user interface of the client device 102 and that is included in the message 400.
A message image payload 406: image data captured by a camera component of a client device 102 or retrieved from memory of a client device 102, and that is included in the message 400.
A message video payload 408: video data captured by a camera component or retrieved from a memory component of the client device 102, and that is included in the message 400.
A message audio payload 410: audio data captured by a microphone or retrieved from the memory component of the client device 102, and that is included in the message 400.
Message annotations 412: annotation data (e.g., filters, stickers, or other enhancements) that represents annotations to be applied to the message image payload 406, message video payload 408, or message audio payload 410 of the message 400.
A message duration parameter 414: a parameter value indicating, in seconds, the amount of time for which content of the message 400 (e.g., the message image payload 406, message video payload 408, and message audio payload 410) is to be presented or made accessible to a user via the messaging client application 104.
A message geolocation parameter 416: geolocation data (e.g., latitudinal and longitudinal coordinates) associated with the content payload of the message 400. Multiple message geolocation parameter 416 values may be included in the payload, with each of these parameter values being associated with respective content items included in the content (e.g., a specific image in the message image payload 406, or a specific video in the message video payload 408).
A message story identifier 418: values identifying one or more content collections (e.g., “stories”) with which a particular content item in the message image payload 406 of the message 400 is associated. For example, multiple images within the message image payload 406 may each be associated with multiple content collections using identifier values.
A message tag 420: one or more tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
A message sender identifier 422: an identifier (e.g., a messaging system identifier, email address, or device identifier) indicative of a user of the client device 102 on which the message 400 was generated and from which the message 400 was sent.
A message receiver identifier 424: an identifier (e.g., a messaging system identifier, email address, or device identifier) indicative of a user of the client device 102 to which the message 400 is addressed.

The contents (e.g., values) of the various components of the message 400 may be pointers to locations in tables within which content data values are stored. For example, an image value in the message image payload 406 may be a pointer to (or address of) a location within the image table 308. Similarly, values within the message video payload 408 may point to data stored within the video table 310, values stored within the message annotations 412 may point to data stored in the annotation table 312, values stored within the message story identifier 418 may point to data stored in the story table 306, and values stored within the message sender identifier 422 and the message receiver identifier 424 may point to user records stored within the entity table 302.

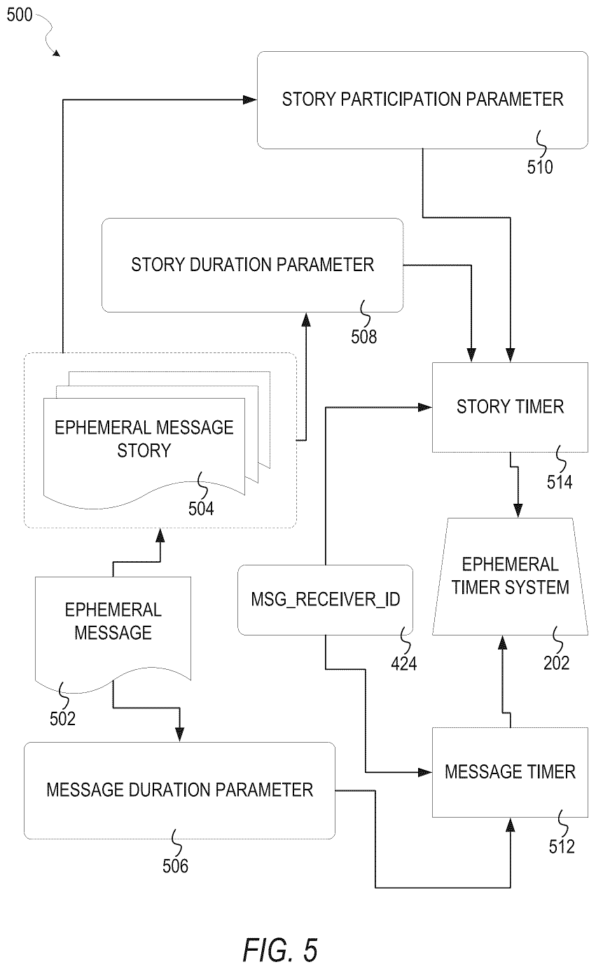

FIG. 5 is a schematic diagram illustrating an access-limiting process 500, in terms of which access to content (e.g., an ephemeral message 502, and associated multimedia payload of data) or a content collection (e.g., an ephemeral message story 504) may be time-limited (e.g., made ephemeral), according to some example embodiments.

An ephemeral message 502 is shown to be associated with a message duration parameter 506, the value of which determines an amount of time that the ephemeral message 502 will be displayed to a receiving user of the ephemeral message 502 by the messaging client application 104. In one embodiment, where the messaging client application 104 is an application client, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 512, which is responsible for determining the amount of time that the ephemeral message 502 is shown to a particular receiving user identified by the message receiver identifier 424. In particular, the ephemeral message 502 will only be shown to the relevant receiving user for a time period determined by the value of the message duration parameter 506. The message timer 512 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message story 504 (e.g., a personal story, or an event story). The ephemeral message story 504 has an associated story duration parameter 508, a value of which determines a time duration for which the ephemeral message story 504 is presented and accessible to users of the messaging system 100. The story duration parameter 508, for example, may be the duration of a music concert, where the ephemeral message story 504 is a collection of content pertaining to that concert. Alternatively, a user (either the owning user or a curator user) may specify the value for the story duration parameter 508 when performing the setup and creation of the ephemeral message story 504.

Additionally, each ephemeral message 502 within the ephemeral message story 504 has an associated story participation parameter 510, a value of which determines the duration of time for which the ephemeral message 502 will be accessible within the context of the ephemeral message story 504. Accordingly, a particular ephemeral message 502 may “expire” and become inaccessible within the context of the ephemeral message story 504, prior to the ephemeral message story 504 itself expiring in terms of the story duration parameter 508.

The ephemeral timer system 202 may furthermore operationally remove a particular ephemeral message 502 from the ephemeral message story 504 based on a determination that it has exceeded an associated story participation parameter 510. For example, when a sending user has established a story participation parameter 510 of 24 hours from posting, the ephemeral timer system 202 will remove the relevant ephemeral message 502 from the ephemeral message story 504 after the specified 24 hours. The ephemeral timer system 202 also operates to remove an ephemeral message story 504 either when the story participation parameter 510 for each and every ephemeral message 502 within the ephemeral message story 504 has expired, or when the ephemeral message story 504 itself has expired in terms of the story duration parameter 508.

In response to the ephemeral timer system 202 determining that an ephemeral message story 504 has expired (e.g., is no longer accessible), the ephemeral timer system 202 communicates with the messaging system 100 (e.g., specifically, the messaging client application 104) to cause an indicium (e.g., an icon) associated with the relevant ephemeral message story 504 to no longer be displayed within a user interface of the messaging client application 104.

The following is an example implementation of the mapping system 123, in accordance with some example embodiments. First, the mapping system 123 performs semantic segmentation classifier training (e.g., image segmentation neural network) on frames from video, such as frames from video social media posts or a client device generated video. For example, the mapping system 123 generates programmatic labels for each frame using a machine learning classifier that is trained to generate image segmentation labels for terrestrial based images (e.g., image data generated from terrestrial based cameras, such as client devices). Second, the mapping system 123 places the semantically labeled image data into geographic space by converting the image frames into point clouds using a photogrammetric computer vision scheme, such as AliceVision. One issue with converting to point clouds is the inaccuracy of the geographic information contained in terrestrial based sources (e.g., side-perspective video, GPS data). In some example embodiments, to address insufficient accuracy, the mapping system 123 uses external spatial reference data sets (e.g., aerial data) to assist geographic rectification of the point cloud. In some example embodiments external reference data is provided from different forms such as aerial generated visual datasets. That is, to address the insufficient accuracy issues, the mapping system 123 implements an external spatial reference data set to assist georectification of the terrestrial-generated point cloud. The external reference could take a variety of forms, such as aerial LiDAR, point clouds that are derived from aerial or satellite oblique based imaging techniques, high-resolution synthetic aperture radar (SAR) or other remotely sensed sources. In some example embodiments, the mapping system 123 pre-processes the point clouds by dividing the video frames into segments (e.g., five second segments) and constructing 3D point clouds in a photogrammetry pipeline (e.g., implementing a photometric imaging scheme, SfM). An example photogrammetry pipeline comprises (1) camera initiation, (2) followed by image feature extraction, (3) followed by image matching, (4) followed by future matching, (5) followed by performing structure from motion (SfM), in accordance with some example embodiments. SfM involves estimating a 3D structure of a scene from a set of two dimensional images. SfM data can be generated in different ways based on different factors, such as the number and type of cameras used, whether the images are ordered, and whether the images are taken from different cameras (e.g., cameras of different user devices).

In some example embodiments, in order to co-register the point cloud to the external spatial reference, the mapping system 123 maximizes a number of possible point matches between the external reference data and the terrestrial based point cloud via densification. In some example embodiments, the additional densification processing is performed due to the two data sets being disparate data sets that are collected from different perspectives, such as orthogonal viewpoints (e.g., a side perspective and a top-down perspective). In some example embodiments, image registration between multiple images (e.g., co-registration) is an image processing technique used to align multiple scenes into a single integrated image.

In some example embodiments, to address these difficulties, the mapping system 123 increases a number of potential points matched by identifying (e.g., interpolating) the aerial data source and the terrestrial data source. In some example embodiments, for the aerial data source, the mapping system 123 densifies point data corresponding to the facades (e.g., sides) of buildings to improve the aerial provided data, because the vertical surfaces (e.g., walls, sides of buildings) often receive few generated points in a given area of collection due to the top-down perspective of the data collecting device. In some example embodiments, the mapping system 123 then semantically segments the LiDAR or 3D point clouds to determine building structures and ground structures. In some example embodiments, the mapping system 123 implements a machine learning neural network trained on the semantically segmented point clouds to perform densification (e.g., neural network based interpolation of points to densify and generate interpolated points).

In some example embodiments, the mapping system 123 then densifies the terrestrial photogrammetry derive point clouds, using a terrestrial densification pipeline comprising: (1) depth mapping, (2) followed by depth map filtering, (3) followed by meshing, (4) followed by mesh filtering. The results of the pipeline generates an improved set of terrestrial point cloud candidates that can be more readily co-registered to the reference external spatial data set (e.g., enhanced reference LiDAR point cloud from one or more aerial devices).

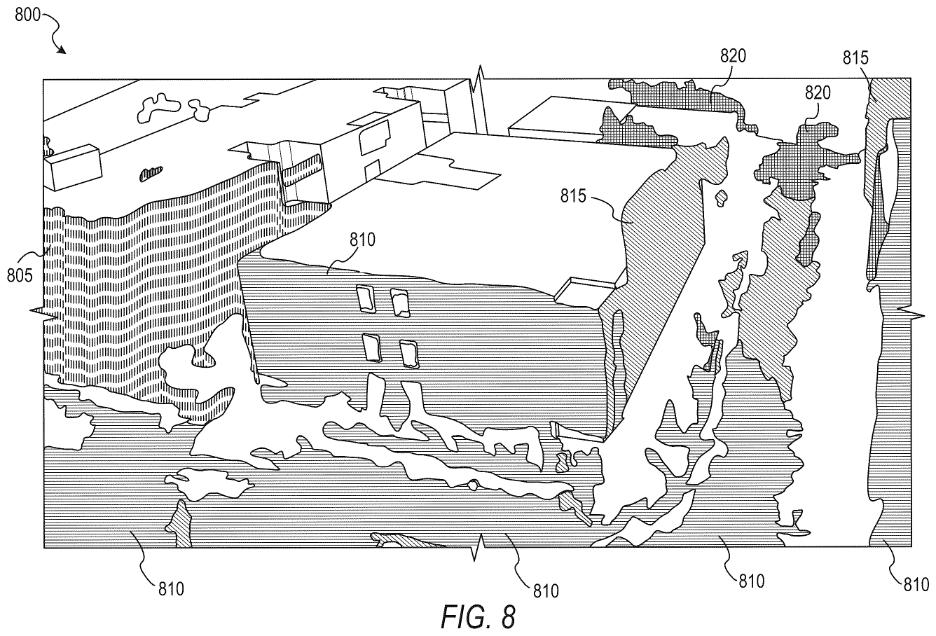

In some example embodiments, co-registration of the two data sets comprises first leveraging GPS data to derive telemetry for approximate point cloud positioning, then performing odometer-based alignment of the SfM point clouds, and then performing pose graph optimization of the SfM point clouds to the external spatial reference data. In this way, the mapping system 123 locks the SfM derived point clouds to a robust spatial reference. In some example embodiments, the mapping system 123 then stitches together each of the SfM point clouds to each other to create a seamless panoramic tapestry for a blended 3D point cloud of a geographic location, such as a downtown area of the city as illustrated in FIG. 8, in which each terrestrial point cloud is colored or shaded differently (e.g., one client device generates images of a building from the right, another from the left, and so on).

One advantage of the segmentation and co-registration processes is that each independent point cloud used to generate a 3D map is relatively small, and therefore does not require a large amount of computation to derive. In this way, when different point clouds are stitched together to generate the 3D mapping, the smaller SfM models ensure that errors do not propagate far (e.g., into adjacent point clouds which can spread error). In this way, each terrestrial point cloud's local errors are never correlated with their adjacent SfM models (e.g., terrestrial point clouds derived from other client devices). Further, in some example embodiments, image chips (e.g., image fragments of an image or video frame)) from the image frames of the client devices that are used to generate the terrestrial point clouds are then stitched (e.g., projected, applied as a surface texture) to the 3D map of FIG. 8, such that the 3D map has a more realistic photographic appearance. In this way, the mapping system generates high accuracy point clouds from commodity cameras (e.g., client device cameras) via enhancement from external spatial reference data sets.

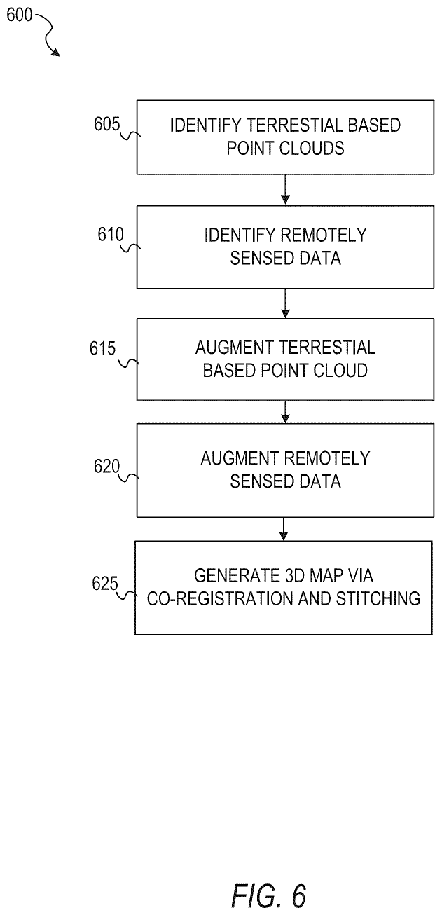

FIG. 6 shows an example flow diagram of a method 600 for generating 3D maps using the mapping system 123 via registration of disparate image sets (e.g., terrestrially based point clouds, aerial based point clouds) generated from orthogonal perspectives, according to some example embodiments. At operation 605, the mapping system 123 identifies the terrestrial point cloud data sets. For example, a plurality of client user devices generate video data of different portions of a geographic location (e.g., a city's downtown area), a point cloud is generated from each client device's video data, and the multiple point clouds are identified by the mapping system 123 for further processing.

At operation 610, the mapping system 123 identifies remotely sensed data. At operation 615, the mapping system 123 augments the terrestrial point cloud data (e.g., densifies the point cloud, neural network based densification to add further points between sparse points).

At operation 620, the mapping system 123 augments a set of remotely sensed data, such as aerial device data of the geographic location taken from a top-down perspective. In some example embodiments, the mapping system 123 augments the remotely sensed data via interpolation (e.g., densification) to densify facades of vertical surfaces (e.g., buildings' exterior walls) captured in the remotely sensed data.

At operation 625, the mapping system 123 generates a 3D map of the physical environment. In some example embodiments, the mapping system 123 generates the 3D map by co-registering the augmented terrestrial point cloud data sets to the augmented remotely sensed data. The co-registering of each augmented terrestrial point cloud data set stitches the patches to each other and with the remotely sensed data to create an accurate 3D map.

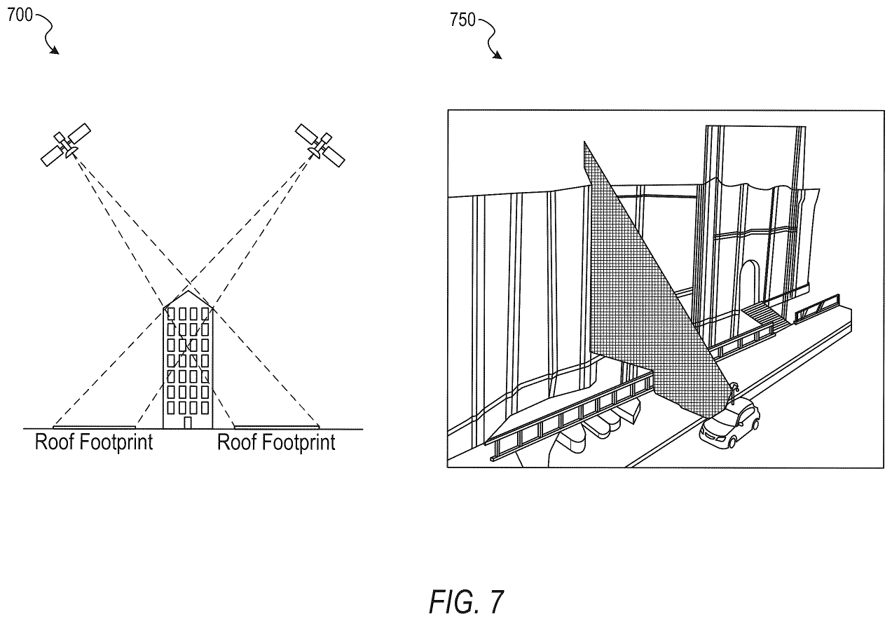

FIG. 7 shows an example of disparate datasets, such as different image data from orthogonal perspectives, according to some example embodiments. In the example top perspective 700, the remotely sensed data comprises data (e.g., images, video, ranging data, point clouds) generated from a top-down perspective. Different remote devices can provide the remotely sensed data, such as planes or satellites that physically move above a geographic location and generate the remotely sensed data using LIDAR or imaging devices (e.g., Complementary metal-oxide-semiconductor (CMOS) camera). In the example side perspective 750, the local data comprises data (e.g., images, video, ranging data, point clouds) generated from terrestrial devices that generate data from a side perspective. Different devices can provide the local data, such as user devices (e.g., smartphones, cameras, car-based imaging systems, ranging systems such as Lidar).

FIG. 8 shows an example 3D map 800 generated of a geographic area (e.g., downtown Boulder, Colorado) that is generated by the mapping system 123, in accordance with some example embodiments. In the illustrated example of FIG. 8, the 3D map 800 is shaded with different patterns to indicate areas of the 3D map 800 that correspond to different point clouds generated from different terrestrial devices (e.g., different end-user devices). The different point clouds depict buildings, streets, and other physical features of a geographic area, such as downtown Boulder, Colorado. For example, a first user device (not depicted) generates video data while a user of the device is stationary or walks around the geographic area, and the video data is then used to create a first SfM-based point cloud area 805, via photometric pipeline, where the processing is implemented as discussed above (e.g., augmentation and co-registration with remotely sensed data), in accordance with some example embodiments

Further, a second user device (not depicted) generates video data while a second user of the second user device is stationary or walks around the geographic area, and the second video data set is then used to create a second SfM-based point cloud area 810 (e.g., which is processed and augmented via the remotely sensed data as discussed above). Further, a third user device (not depicted) generates a third video data set while a third user of the third user device is stationary or walks around the geographic area, and the third video data set is then used to create a third SfM-based point cloud area 815 (e.g., which is processed and augmented via the remotely sensed data as discussed above).

Further, a fourth user device (not depicted) generates a fourth video data set while a fourth user of the fourth user device is stationary or walks around the geographic area, and the fourth video data set is then used to create a fourth SfM-based point cloud area 820 (e.g., which is processed and augmented via the remotely sensed data as discussed above). The resulting point clouds can then be stitched together to create the map 800 (e.g., a full 3D panoramic map of the geographic area) In some example embodiments, the video data sets are clips of social media posts (e.g., ephemeral messages), while in other example embodiments, the video data sets comprise video data created from commodity off the shelf consumer imaging solutions, such as video recorders, digital single lens reflex camera (DSLR) or mirrorless cameras.

As discussed above, one benefit of the independently derived point cloud areas 805, 810, 815, and 820 is that the error is localized into individual point cloud areas and does not spread into adjacent areas. This can be beneficial where, for example, one of the point clouds is inaccurate (e.g., due to poor quality video or aerial data), while still enabling creation of a highly useful 3D map 800.

In some example embodiments, the 3D map 800 does not display the different patterns of the different point clouds and instead image chips (e.g., image fragments) of the video data are applied as an image texture to the 3D map 800 so that the 3D map 800 appears more photo-realistic.

Example 1. A method comprising: identifying terrestrial source image data generated using a plurality of client devices; identifying aerial based image data that is generated from an orthogonal perspective relative to the terrestrial source image data; generating enhanced terrestrial source image data by correlating points of the terrestrial source image data and the aerial based image data; generating a three-dimensional map from the enhanced terrestrial source image data, the 3D map comprising stitched portions of enhanced terrestrial source image data sets from different client devices of the plurality of client devices.

Example 2. The method of example 1, wherein the terrestrial source image data comprises a plurality of point clouds.

Example 3. The method of any of the examples 1 or 2, wherein the plurality of point clouds are generated by applying an imaging scheme to video sequences generated by the plurality of client devices.

Example 4. The method of any of the examples 1-3, wherein the imaging scheme is a photometric imaging scheme that generates point cloud data from image data.

Example 5. The method of any of the examples 1-4, wherein the aerial based image data is generated by aerial vehicles.

Example 6. The method of any of the examples 1-9wherein the aerial based image data comprises aerial lidar data that images a ground from a top-down perspective.

Example 7. The method of any of the examples 1-9 further comprising: enhancing the terrestrial source image data by performing densification to add image details using interpolation.

Example 8. The method of any of the examples 1-9 wherein a machine learning scheme is trained to perform densification to the terrestrial source image data.

Example 9. The method of any of the examples 1-9, further comprising: enhancing the terrestrial source image data by performing densification to add image details using interpolation.

Example 10. The method of any of the examples 1-9, wherein the correlating points comprises applying an point co-registration scheme to correlate of the terrestrial source image data and the aerial based image data.

Example 11. A system comprising: one or more processors of a machine; and at least one memory storing instructions that, when executed by the one or more processors, cause the machine to perform any of the methods of examples 10.

Example 12. A machine-storage media embodying instructions that, when executed by a machine, cause the machine to perform any of the methods of examples 1-10.

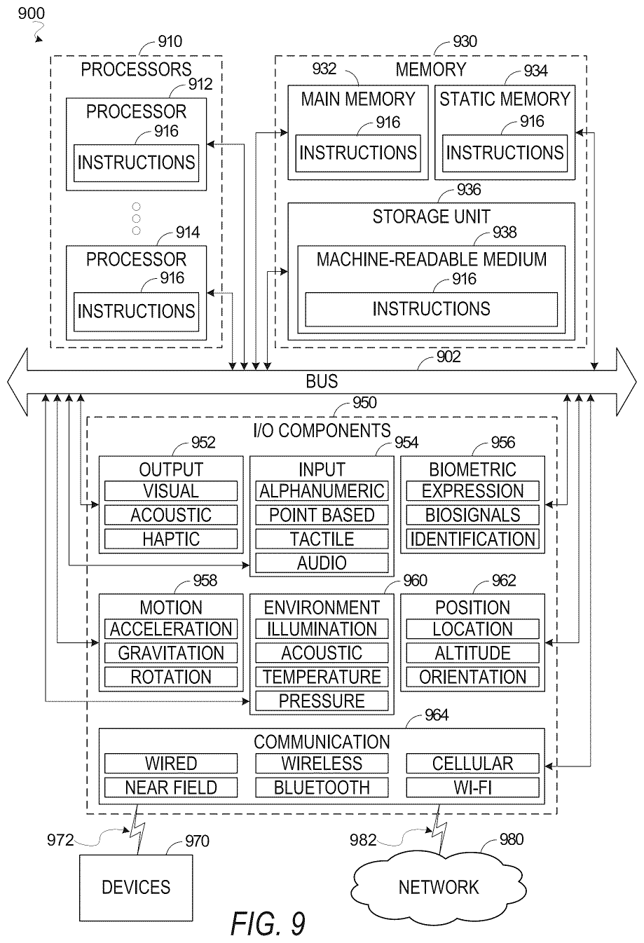

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. As such, the instructions 916 may be used to implement modules or components described herein. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines that individually or jointly execute the instructions 916 to perform any one or more of the methodologies discussed herein.

The machine 900 may include processors 910, memory/storage 930, and input/output (I/O) components 950, which may be configured to communicate with each other such as via a bus 902. The memory/storage 930 may include a main memory 932, static memory 934, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936 (e.g., on machine readable-medium 938), within at least one of the processors 910 (e.g., within the processor cache memory accessible to processors 912 or 914), or any suitable combination thereof, during execution thereof by the machine 900. Accordingly, the memory 932, the storage unit 936, and the memory of the processors 910 are examples of machine-readable media.

The I/O components 950 may include a wide variety of components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid-crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environment components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environment components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or other suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional barcodes such as Universal Product Code (UPC) barcode, multi-dimensional barcodes such as Quick Response (QR) code, Aztec code, Data Matrix, Dataglyph, MaxiCode, PDF418, Ultra Code, UCC RSS-2D barcode, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

“CARRIER SIGNAL” in this context refers to any intangible medium that is capable of storing, encoding, or carrying instructions 916 for execution by the machine 900, and includes digital or analog communications signals or other intangible media to facilitate communication of such instructions 916. Instructions 916 may be transmitted or received over the network 980 using a transmission medium via a network interface device and using any one of a number of well-known transfer protocols.

“CLIENT DEVICE” in this context refers to any machine 900 that interfaces to a network 980 to obtain resources from one or more server systems or other client devices 102. A client device 102 may be, but is not limited to, a mobile phone, desktop computer, laptop, PDA, smartphone, tablet, ultrabook, netbook, multi-processor system, microprocessor-based or programmable consumer electronics system, game console, STB, or any other communication device that a user may use to access a network 980.

“COMMUNICATIONS NETWORK” in this context refers to one or more portions of a network 980 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network 980 may include a wireless or cellular network and the coupling 982 may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“EPHEMERAL MESSAGE” in this context refers to a message 400 that is accessible for a time-limited duration. An ephemeral message 502 may be a text, an image, a video, and the like. The access time for the ephemeral message 502 may be set by the message sender. Alternatively, the access time may be a default setting, or a setting specified by the recipient. Regardless of the setting technique, the message 400 is transitory.

“MACHINE-READABLE MEDIUM” in this context refers to a component, a device, or other tangible media able to store instructions 916 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions 916 (e.g., code) for execution by a machine 900, such that the instructions 916, when executed by one or more processors 910 of the machine 900, cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor 912 or a group of processors 910) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine 900) uniquely tailored to perform the configured functions and are no longer general-purpose processors 910.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware components are temporarily configured (e.g., programmed), each of the hardware components need not be configured or instantiated at any one instance in time. For example, where a hardware component comprises a general-purpose processor 912 configured by software to become a special-purpose processor, the general-purpose processor 912 may be configured as respectively different special-purpose processors (e.g., comprising different hardware components) at different times. Software accordingly configures a particular processor 912 or processors 910, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 910 that are temporarily configured (e.g., by software) or permanently configured to perform the relevant operations. Whether temporarily or permanently configured, such processors 910 may constitute processor-implemented components that operate to perform one or more operations or functions described herein. As used herein, “processor-implemented component” refers to a hardware component implemented using one or more processors 910. Similarly, the methods described herein may be at least partially processor-implemented, with a particular processor 912 or processors 910 being an example of hardware. For example, at least some of the operations of a method may be performed by one or more processors 910 or processor-implemented components. Moreover, the one or more processors 910 may also operate to support performance of the relevant operations in a “cloud computing” environment or as a “software as a service” (SaaS). For example, at least some of the operations may be performed by a group of computers (as examples of machines 900 including processors 910), with these operations being accessible via a network 980 (e.g., the Internet) and via one or more appropriate interfaces (e.g., an API). The performance of certain of the operations may be distributed among the processors 910, not only residing within a single machine 900, but deployed across a number of machines 900. In some example embodiments, the processors 910 or processor-implemented components may be located in a single geographic location (e.g., within a home environment, an office environment, or a server farm). In other example embodiments, the processors 910 or processor-implemented components may be distributed across a number of geographic locations.

“PROCESSOR” in this context refers to any circuit or virtual circuit (a physical circuit emulated by logic executing on an actual processor 912) that manipulates data values according to control signals (e.g., “commands,” “op codes,” “machine code,” etc.) and which produces corresponding output signals that are applied to operate a machine 900. A processor may, for example, be a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), or any combination thereof. A processor 910 may further be a multi-core processor 910 having two or more independent processors 912, 99 (sometimes referred to as “cores”) that may execute instructions 916 contemporaneously.

“TIMESTAMP” in this context refers to a sequence of characters or encoded information identifying when a certain event occurred, for example giving date and time of day, sometimes accurate to a small fraction of a second.

What is claimed is:

1. A method comprising:
generating labels for image data from a plurality of computing devices using a machine learning model;
converting the image data into point clouds using a computer vision scheme;
placing the image data and the point clouds into a geographic space based on the labels for the image data; and
generating a three-dimensional map from the image data, the three-dimensional map comprising stitched portions of the image data from different computing devices of the plurality of computing devices, the three-dimensional map generated by correlating points of the point clouds with reference points of a reference point cloud for the geographic space.

2. The method of claim 1, further comprising:
adjusting placements of the point clouds based on an external spatial reference data set.

3. The method of claim 1, wherein converting the image data into point clouds comprises:
dividing the image data into segments, wherein each point cloud is constructed based on a corresponding segment.

4. The method of claim 1, further comprising:
estimating a three-dimensional structure in the geographic space based on the point clouds.

5. The method of claim 1, wherein placing the image data and the point clouds into the geographic space comprises:
deriving telemetry for approximate positions of the point clouds based on GPS data;
aligning the point clouds based on odometer data; and
performing pose graph optimization of the point clouds based on an external spatial reference data set.

6. The method of claim 1, wherein generating the three-dimensional map comprises:
blending the point clouds into one three-dimensional point cloud of the geographic space.

7. The method of claim 1, wherein generating the three-dimensional map comprises:
applying image fragments of the image data to the point clouds as surface textures.

8. The method of claim 1, further comprising:
generating interpolated points based on the point clouds, wherein image detail is added to the three-dimensional map based on the interpolated points.

9. The method of claim 1, wherein the reference point cloud is generated based on aerial based image data.

10. The method of claim 1, wherein propagation of local errors within the point clouds is prevented by preventing correlation between the point clouds.

11. A system comprising:
one or more processors; and
memory storing instructions that, when executed by the one or more processors, cause the system to perform operations comprising:
generating labels for image data from a plurality of computing devices using a machine learning model;
converting the image data into point clouds using a computer vision scheme;
placing the image data and the point clouds into a geographic space based on the labels for the image data; and
generating a three-dimensional map from the image data, the three-dimensional map comprising stitched portions of the image data from different computing devices of the plurality of computing devices, the three-dimensional map generated by correlating points of the point clouds with reference points of a reference point cloud for the geographic space.

12. The system of claim 11, the operations further comprising:
adjusting placements of the point clouds based on an external spatial reference data set.

13. The system of claim 11, wherein converting the image data into point clouds comprises:
dividing the image data into segments, wherein each point cloud is constructed based on a corresponding segment.

14. The system of claim 11, the operations further comprising:
estimating a three-dimensional structure in the geographic space based on the point clouds.

15. The system of claim 11, wherein placing the image data and the point clouds into the geographic space comprises:
deriving telemetry for approximate positions of the point clouds based on GPS data;
aligning the point clouds based on odometer data; and
performing pose graph optimization of the point clouds based on an external spatial reference data set.

16. The system of claim 11, wherein generating the three-dimensional map comprises:
blending the point clouds into one three-dimensional point cloud of the geographic space.

17. The system of claim 11, wherein generating the three-dimensional map comprises:
applying image fragments of the image data to the point clouds as surface textures.

18. The system of claim 11, the operations further comprising:
generating interpolated points based on the point clouds, wherein image detail is added to the three-dimensional map based on the interpolated points.

19. The system of claim 11, wherein the reference point cloud is generated based on aerial based image data.

20. A non-transitory, machine-readable medium storing instructions that, when executed by a machine, cause the machine to perform operations comprising:
generating labels for image data from a plurality of computing devices using a machine learning model;
converting the image data into point clouds using a computer vision scheme;
placing the image data and the point clouds into a geographic space based on the labels for the image data; and
generating a three-dimensional map from the image data, the three-dimensional map comprising stitched portions of the image data from different computing devices of the plurality of computing devices, the three-dimensional map generated by correlating points of the point clouds with reference points of a reference point cloud for the geographic space.
